(19) United States
(12) Patent Application Publication
(10) Pub. No.: US 2018/0142842 A1
(43) Pub. Date: May 24, 2018

(54) Illumination device comprising semiconductor primary light sources and at least one luminophore element

(71) Applicants: OSRAM GmbH, Munich (DE); Robert Bosch GmbH, Stuttgart-Feuerbach (DE)

(72) Inventors: Stephan SCHWAIGER, Herbrechtingen (DE); Andreas PETERSEN, Marbach (DE); Frank SCHATZ, Kornwestheim (DE)

(21) Appl. No.: 15/568,496

(22) PCT Filed: Apr. 22, 2016
(86) PCT No.: PCT/EP2016/059077

§ 371 Date: Oct. 23, 2017

(30) Foreign Application Priority Data
Apr. 24, 2015 (DE) 10 2015 106 312.3

(51) Int. Cl. F21K 9/64; F21S 41/663; F21V 14/04; F21V 7/04; F21S 41/16; F21S 41/20; F21S 41/63

(52) U.S. Cl. CPC F21K 9/64; F21S 41/663; F21V 14/04; F21Y 2115/30; F21S 41/16; F21S 41/285; F21S 41/635; F21V 7/04

(57) ABSTRACT

According to the present disclosure, an illumination device is provided with a plurality of semiconductor primary light sources for emitting respective primary light beams, a beam deflection unit, which is illuminatable by the primary light beams and which can assume at least two beam deflection positions, and a luminophore body, which is illuminatable by primary light beams deflected by the beam deflection unit. Luminous spots of the individual primary light beams are spatially distinguishable on the at least one luminophore body, a total luminous spot composed of the luminous spots of the individual primary light beams is spatially distinguishable on the at least one luminophore body depending on the beam deflection position of the beam deflection unit, and at least one primary light beam incident on the at least one luminophore body is selectively switchable on and off during operation of the illumination device.

### RELATED APPLICATIONS

The present application is a national stage entry according to 35 U.S.C. § 371 of PCT application No.: PCT/EP2016/059077 filed on Apr. 22, 2016, which claims priority from German application No.: 10 2015 106 312.3 filed on Apr. 24, 2015, and is incorporated herein by reference in its entirety.

### TECHNICAL FIELD

The present disclosure relates to an illumination device, including a plurality of semiconductor primary light sources for emitting respective primary light beams, a beam deflection unit, which is illuminatable by means of the primary light beams and which can assume at least two beam deflection positions, and at least one luminophore body, which is illuminatable by means of primary light beams deflected by the beam deflection unit. The present disclosure is applicable for example to projection devices, in particular vehicle headlights or devices for professional illumination, for example for effect illumination, e.g. as a stage spotlight or as a disco luminaire.

### BACKGROUND

Simple headlights in the motor vehicle sector nowadays offer a choice between a plurality of fixedly defined light distributions such as e.g. low beam, high beam and fog light.

So-called “adaptive” headlight systems having variable light distributions supplement this selection and offer for example dynamic cornering light, interstate highway light, city light and poor weather light. The selection of the light distributions is carried out by the headlight system or the central electronics of the vehicle partly in a manner governed by the situation.

Moreover, in the field of vehicle lighting there exist so-called “active” headlights, in which a limited number of pixels arranged in columns can be generated. Active headlights make it possible, for example, to mask out oncoming vehicles and vehicles ahead within the own high beam cone (“dazzle-free high beam”) or to highlight hazard sources by direct illumination for the driver. One possible technical implementation of an active headlight is based on a luminophore that is excitable by means of laser radiation. In this case, the luminophore is scanned by the exciting radiation and then imaged with the aid of a projection optical unit. The principle is described for example in the documents DE 10 2010 028 949 A1, US 2014/0029282 A1 and WO 2014/121314 A1. Said documents describe that dynamically adaptable light distributions are generated on the luminophore by virtue of the fact that the laser radiation used for exciting the luminophore is controlled with the aid of a drivable light deflection unit in the form of a movable micromirror. In this case (as described in US 2014/0029282 A1), a desired light distribution can be achieved via an intensity modulation of the laser source, via an adaptation of the angular velocity of the deflection unit and also via a combination of both mechanisms.

The luminophores necessary for wavelength conversion or conversion of the laser light, owing to so-called “thermal quenching”, are limited with regard to their conversion rate or a maximum acceptable power density (e.g. on account of their physical material properties such as durability vis a vis “laser ablation”) and thus with regard to their maximum luminance. This limit of the luminance limits the resulting luminous flux per cross-sectional area of the luminophore element that is illuminated (by the laser beam). In order to achieve the luminous flux necessary e.g. for a headlight, a minimum illuminated area on the luminophore element and thus also a minimum cross-sectional area of the laser beam are therefore necessary. While the luminous flux increases as the beam diameter increases (with constant power density of the beam), the achievable resolution decreases. There thus exists a conflict of goals between the resolution and the achievable luminous flux. An increase in the resolution causes a reduction of the luminous flux per pixel, and vice versa. The only possibility for avoiding the negative consequences of the luminance limitation of the luminophore without reducing the resolution consists in distributing the luminous flux among a plurality of laser beams. The technical realizations thereof have the disadvantage that they entail a high adjustment complexity and require a large amount of structural space for the arrangement of the light sources and/or the deflection units.

### SUMMARY

The object of the present disclosure is to at least partly overcome the disadvantages of the prior art and in particular to provide a compact illumination device which enables a high resolution in conjunction with high luminous flux without great driving and/or adjustment complexity.

This object is achieved in accordance with the features of the independent claims. Preferred embodiments can be gathered in particular from the dependent claims.

The object is achieved by means of an illumination device, including a plurality of semiconductor primary light sources for emitting respective primary light beams, a beam deflection unit, which is illuminatable by means of the primary light beams and which can assume at least two beam deflection positions, and
a luminophore body, which is illuminatable by means of primary light beams deflected by the beam deflection unit, wherein—in at least one beam deflection position luminous spots of the individual primary light beams (also referred to as “individual luminous spots”) are spatially distinguishable on the at least one luminophore body, a total luminous spot composed of the individual luminous spots is spatially distinguishable on the at least one luminophore body depending on the beam deflection position of the beam deflection unit, and at least one primary light beam incident on the at least one luminophore body is selectively switchable on and off during operation of the illumination device.

By means of this illumination device it becomes possible to achieve a high resolution since not only is a position of the total luminous spot on the luminophore body spatially variable, but also the individual primary light beams (or “individual beams”) can be varied by switching on and off, e.g. also depending on a position of the total luminous spot. Furthermore, driving and adjustment of the beam deflection unit and/or of the semiconductor primary light sources is thus simplified. In particular, the individual primary light beams (also able to be referred to as “individual primary light beams” or “individual beams”) can now be directed onto the luminophore with a relatively low adjustment complexity, without reducing the resolution or the luminous flux in the process. A further advantage is that the adjustment of the individual semiconductor primary light sources with respect to one another need no longer be performed at the system level, but rather can already be implemented by the manufacturer of the semiconductor primary light sources.

Thus, by virtue of the individual beams, the total luminous spot (and thus also a total light beam composed of the individual primary light beams) is intrinsically segmented or partly switchable and thereby diversely variable. In this regard, it becomes possible, inter alia, to dynamically adapt an intensity profile of a useful light emitted by the luminophore, or a light emission pattern emitted by the illumination device, with particularly fine resolution with a low structural complexity. In this case, at least two individual luminous spots can partly overlap or be separated. The segmentability of the total luminous spot therefore does not necessarily also include a sharp separation of the individual luminous spots from one another. In principle—e.g. also depending on a beam deflection position of the beam deflection unit—the total luminous spot can be a single continuous luminous spot or include a plurality of luminous partial regions that are spatially separated from one another. The spatially separated luminous partial regions can each again be composed of a plurality of individual luminous spots.

In the case of this illumination device, therefore, at least one total luminous spot which is composed of all the luminous spots of the individual primary light beams can be moved uniformly on the luminophore body by means of the beam deflection unit, while at least some individual primary light beams are selectively switchable on and off.

A “beam deflection position” can be understood to mean in particular a position of the beam deflection unit in which an incident primary light beam is deflected in a predefined spatial direction. Different beam deflection positions have the effect that an incident primary light beam is deflected in different spatial directions. A beam deflection position can be for example a mechanical position (e.g. an angular position or a stroke position) and/or an electrical or electronic setting (e.g. a voltage level or a code sequences).

The selective switchability on and off of at least one semiconductor primary light source includes the fact that at least one semiconductor primary light source of a plurality of semiconductor primary light sources is switchable on and off individually and/or in groups. In a development that is advantageous for a particularly varied formation of a useful light beam, all the semiconductor primary light sources are switchable on and off individually, which allows a particularly varied setting of the light emission pattern. Alternatively, however, the illumination device can also include at least one primary light beam that is not selectively switchable on and off. At least one semiconductor primary light source may be switchable on and off individually or in groups—e.g. depending on a predefined application.

The selective switchability on and off may include the fact that the associated semiconductor primary light source is selectively activatable or deactivatable for generating or not generating a primarily light beam. The selective switchability on and off can also include the fact that a generated primary light beam is selectively transmittable or blockable. The blocking can be achieved for example by means of respective diaphragms or shutters.

The luminophore body can be present or used in a reflective arrangement and/or in a transmissive arrangement. In the case of the reflective arrangement, that light emitted by the luminophore body which is emitted from that side of the luminophore body on which the primary light beams are also incident is used as useful light. In the case of the transmissive arrangement, that light emitted by the luminophore body which is emitted from that side of the luminophore body which faces away with respect to the incident primary light beams is used as useful light. In particular, a both reflective and transmissive arrangement is also implementable. Primarily in a transmissive arrangement, further optical elements, such as dichroic mirrors, for example, are realizable for increasing the efficiency.

The luminophore body includes at least one luminophore suitable for converting incident primary light at least partly into secondary light of a different wavelength. If a plurality of luminophores are present, they may generate secondary light of mutually different wavelengths and/or generate the secondary light as a result of primary light of different wavelengths. The wavelength of the secondary light may be longer (so-called “down conversion”) or shorter (so-called “up conversion”) than the wavelength of the primary light. By way of example, blue primary light (e.g. having a wavelength of approximately 450 nm) may be converted into green, yellow, orange or red secondary light by means of a luminophore. In the case of only partial wavelength conversion, the luminophore body emits a mixture of secondary light (e.g. yellow) and unconverted primary light (e.g. blue), which mixture can serve as useful light (e.g. white).

The luminophore body can be a (flat) luminophore lamina, for example in the form of a ceramic. The luminophore lamina can be planar at least at the surface that is irradiatable by the primary light beams. The luminophore lamina can have a constant thickness or a varying thickness. It can have a round or quadrilateral edge contour, for example.

Alternatively or additionally, the luminophore lamina can also be embodied as non-planar, for example curved or undulately, at least at the surface that is irradiatable by the primary light beams.

The luminophore body can be an individual luminophore body produced in a continuous fashion, which can also be referred to as an integral luminophore body. Alternatively, the luminophore body can be composed of separately produced partial segments that are offset and/or rotated and/or inclined and/or tilted relative to one another, wherein the partial segments can, but need not, be arranged on a common plane. Said partial segments or partial luminophore bodies can have identical or different conversion properties (e.g. with regard to a degree of conversion, a luminophore used, etc.). If a plurality of partial luminophore bodies are present, at least two thereof can closely adjoin one another, e.g. butt against one another.

The luminophore body can be e.g. a rectangular or a round luminophore body. The luminophore body can have a largest diameter of 20 mm or less. A rectangular luminophore body can have e.g. edge dimensions of 5×20 mm or 20×5 mm.

The fact that luminous spots of the individual primary light beams or the individual luminous spots thereof are spatially distinguishable on the at least one luminophore body can also be referred to as a “laterally disjoint” arrangement or simply just a “disjoint” arrangement. The disjoint arrangement includes the fact that adjacent luminous spots laterally are separated from one another or only partly overlap. The disjoint arrangement results in particular from the fact that locations of maximum luminance and/or centers of adjacent luminous spots do not impinge on one another, but rather are spaced apart laterally with respect to one another. A center of a luminous spot can be understood to mean in particular its geometric centroid (if appropriate weighted with the luminance).

In one development, at least two individual primary light beams or individual luminous spots are spatially distinguishable on the at least one luminophore body and at least two primary light beams or individual luminous spots lie one directly on top of another on the at least one luminophore body. Individual luminous spots “lying one directly on top of another” have in particular the same geometric centroid. Individual luminous spots lying one directly on top of another can have identical or different properties (e.g. diameters). The use of individual luminous spots lying one directly on top of another makes it possible to achieve an even greater variation of the luminance distribution on the luminophore body and thus of the light emission pattern.

A partial overlap is afforded in particular if edges of adjacent luminous spots overlap. An edge of a luminous spot can encompass for example the region in which a luminance of at least 5%, in particular of at least 10%, in particular of at least 1/e² (corresponding to approximately 13.5%), in particular of 1/e (corresponding to approximately 36.8%), of the maximum luminance of said luminous spot is achieved. An arrangement separated from one another is analogously achieved if the edges do not overlap.

In particular, the at least one semiconductor primary light source includes at least one laser, for example at least one laser diode. The laser diode can be present in the form of at least one individually packaged laser diode or in unpackaged form, e.g. as at least one chip or “die”. In particular, a plurality of laser diodes can be present as at least one multi-die package or as at least one laser bar. By way of example, the multi-die laser package PLPM4 450 from Osram Opto Semiconductors can be used. A plurality of chips can be mounted on a common substrate (“submount”). By way of example, at least one light emitting diode can also be used instead of a laser.

In one development, the at least one semiconductor primary light source includes at least four, in particular at least 20, in particular at least 30, in particular at least 40, semiconductor primary light sources. The higher the number of semiconductor primary light sources, the higher an achievable light intensity in the far field and the less stringent requirements that need to be applied to a possibly required movement of the beam deflection unit.

Furthermore, in one development, the semiconductor primary light sources are configured to radiate or emit all the primary light beams parallel to one another. This can be achieved e.g. by fitting the semiconductor primary light sources on one or more common carriers. For this development, in particular, all the semiconductor primary light sources can be arranged on a common carrier, in particular printed circuit board, e.g. as at least one multi-die package or as at least one laser bar.

In another development, the semiconductor primary light sources are arranged in a regular area pattern, in particular in a symmetrical area pattern, for example in a rectangular matrix pattern or in a hexagonal pattern. This affords the advantage that a totality of all the individual luminous spots generatable during an image set-up time can likewise be formed regularly, in particular symmetrically, in a simple manner on the luminophore body or form a regular pattern there, for example a matrix pattern. In this regard, in particular, undesired sudden changes in luminance or undesired luminance gaps between adjacent luminous spots can be avoided.

A first optical unit in the form of a “primary optical unit” can be disposed downstream of the plurality of semiconductor primary light sources and e.g. collimates the individual primary light beams emitted by the semiconductor primary light sources.

A second optical unit including at least one optical element can be arranged in the light path between the plurality of semiconductor primary light sources or—if present—the first primary optical unit and the beam deflection unit. A third optical unit including at least one optical element can be arranged in the light path between the beam deflection unit and the at least one luminophore body. A fourth optical unit including at least one optical element for the beam shaping of the useful light can be disposed optically downstream of the at least one luminophore body. The third optical unit and the fourth optical unit may include at least one common optical element, for example at least one optical element for focusing the primary light beams onto the luminophore body and for coupling out the useful light emitted by the luminophore body.

In one configuration, the beam deflection unit includes at least one movable mirror, which is illuminatable by means of the primary light beams and which can assume at least two angular positions as beam deflection positions. This configuration affords the advantage that it is implementable in a comparatively simple, compact, long-lived and inexpensive fashion.

The at least one movable mirror may include in particular at least one rotatable, or pivotable mirror, but can additionally or alternatively also be displaceable.

In one development, the at least one movable mirror is exactly one mirror, which enables a particularly simple construction. Such a mirror is pivotable or rotatable in particular about two mutually perpendicular rotation axes, e.g. about an x-axis and about a y-axis. This enables in principle any desired position of the total luminous spot on the luminophore body with just one mirror, for example a line-wise and/or column-wise or Lissajous figure-like illumination of the luminophore body. This in turn enables an e.g. line-/column-wise or Lissajous figure-like generation of a light emission pattern established by the useful light.

Moreover, in one development, the at least one movable mirror includes a plurality of movable mirrors. The latter can deflect the primary light beams for example in respectively different spatial directions, e.g. for establishing the light emission pattern in a line- and/or column-wise manner. In this regard, in one development, the at least one movable mirror illuminatable by means of the primary light beams includes a respective rotatable mirror per rotation axis, for example a rotatable mirror for the x-axis and a downstream rotatable mirror for the y-axis, or vice versa. Such mirrors are implementable in a particularly simple manner.

Moreover, in one variant, only an individual mirror rotatable about a single rotation axis is used. An image set-up is then made possible for example by a total luminous spot having a magnitude (e.g. having a height or width) in a second image direction (e.g. an image height or an image width) such that it occupies the entire second image direction. In this case, in particular, the resolution in the second image direction can be effected via the switching on or off of the individual beams. The semiconductor primary light sources can then be arranged in a series, for example.

In a configuration as an alternative or in addition to the use of at least one mirror, the beam deflection unit includes an array of phase shifters, which enables a light redistribution by constructive or destructive interference in desired angular ranges or for desired beam deflection positions. Possible embodiments include for example an array of vertically displaceable MEMS mirrors (“piston-like array”) or e.g. an LCD-based phase shifter array.

In another development, the second optical unit is configured and arranged to direct at least two individual primary light beams emitted by the semiconductor primary light sources onto the at least one mirror at different angles. As a result, it is possible to use a particularly small mirror, in particular a micromirror. The second optical unit can be configured and arranged in particular to focus a plurality of primary light beams that are incident in a parallel manner onto the mirror.

Moreover, in one development, the second optical unit is configured and arranged to direct two individual primary light beams emitted by the semiconductor primary light sources onto the at least one mirror in a manner parallel to one another, but in a laterally disjoint fashion.

Moreover, in one configuration, the at least one movable mirror includes at least one micromirror. In this regard, a particularly compact arrangement can be achieved. The micromirror can be a MEMS component, which can then also be referred to as MEMS mirror. At least one micromirror can have a single continuous movable mirror surface. At least one micromirror can have a plurality of—in particular mutually independently—movable mirror surfaces. It can then be present in particular as a micromirror array, e.g. as a DMD (“Digital Micromirror Device”). A micromirror (or a matrix-like arrangement of micromirrors) can be driven in a resonant or non-resonant manner with regard to its oscillation behavior. The dynamic sequence of the angular positions of a micromirror can be effected in a sinusoidal or non-sinusoidal manner, in particular with a temporally linear or a temporally nonlinear deflection. Commercially available MEMS mirrors have a deflection of +/−(10° . . . 12°).

At least one micromirror can be movable, in particular pivotable, by an actuator system, for example in a stepwise or continuously variable manner. In this case, the respective angular positions correspond to the respective positions of a total primary light beam on the at least one luminophore body or the respective total luminous spot. The at least one associated actuator (e.g. a piezoactuator with or without stroke amplification) can be embodied or used as a stepper motor. Alternatively or additionally, at least one micromirror can be continuously rotatable by means of a driveshaft, specifically between two end positions or in a spinning manner. The actuator can then be an electric motor. By way of example, using a mirror that is pivotable in a stepwise manner and using a continuously rotatable mirror, a set-up similar to a so-called “flying spot” method can be achieved.

In addition, in one configuration, the at least one luminophore body is illuminatable in a track-like manner with a total light beam constituted by the individual primary light beams, or the total luminous spot is movable or “scannable” in a track-like manner on the luminophore body.

The track-like movement can be e.g. a line- or column-like movement or a movement in accordance with a Lissajous figure. The inverse of the time duration required for sweeping over a line or column can be referred to as horizontal scan frequency or line frequency or vertical scan frequency or line frequency.

In one development, the individual primary light beams are switchable on and off with a switching frequency that is at least 10 times, in particular at least 100 times, in particular at least 1000 times, in particular at least 10 000 times, higher than the scan frequency. In this regard, for example, a pulse frequency of the semiconductor primary light sources can be correspondingly higher than the scan frequency.

The time duration of a cycle for illuminating the luminophore body is also referred to as “image set-up time”, and the associated frequency as “image set-up frequency”. The image set-up frequency for sufficiently high temporal resolution of a light emission pattern even in a far field is advantageously at least 50 Hz, particularly advantageously at least 75 Hz, especially advantageously at least 100 Hz, in particular at least 200 Hz.

In another configuration, moreover, differently positioned and thus in particular also successively generated total luminous spots at least partly overlap the at least one luminophore body, namely in a so-called “overlap region” of the luminophore body. A particularly high temporally integrated luminance can be achieved there. In other words, in one configuration, total luminous spots associated with different beam deflection positions of the beam deflection unit (e.g. with different angular positions of the at least one mirror) at least partly overlap.

In one configuration thereof, at least two individual luminous spots which belong to different total luminous spots can be superimposed. In other words, individual luminous spots of different total light beams can overlap in a temporally offset manner, but congruently in the overlap region. As a result, it is possible to provide a particularly diversely generatable luminous pattern on the luminophore body and light emission pattern emitable by the illumination device. In particular, it is thus possible to achieve a graduated temporally integrated luminance of individual luminous regions in an overlap region of the luminophore body just by switching the individual primary light beams on and off. Moreover, a particularly high resolution can thus be achieved.

In another configuration thereof, at least two series (e.g. columns or lines) of luminous spots of individual primary light beams which belong to different total luminous spots can be superimposed. As a result, a high resolution and a high temporally integrated luminance are made possible in a particularly simple manner for e.g. sweeping over or scanning the luminophore body in a line- or column-like manner.

In a configuration that is advantageous for a mechanically particularly simply configurable and rapidly switching movement mechanism of at least one mirror, the total luminous spots—associated with different angular positions—are spatially separated from one another.

During an image set-up, in principle, some total luminous spots can be generated in a manner entirely overlapping one another on the luminophore body and other total luminous spots can be generated in a spatially distinguishable or disjoint manner on the luminophore body (i.e. in an only partly overlapping or spatially separated manner).

In another configuration, moreover, a switch-on pattern (i.e. a pattern of switch-on and switch-off states) of the generatable luminous spots is dependent on the beam deflection position of the beam deflection unit (e.g. on the angular position of the at least one movable mirror).

Furthermore, in one configuration, the total luminous spot has a maximum achievable planar extent which does not exceed 20% of a corresponding extent of the luminophore body or of the illuminatable area thereof, in particular does not exceed 10%, in particular 5%, in particular 2%, in particular 1%. A particularly high luminance of the luminous spots can be achieved as a result. By changing the beam deflection position of the beam deflection unit (e.g. the angular position of the at least one mirror) it is possible to generate within an illumination cycle or within an image set-up time a plurality of disjoint total luminous spots which together cover more than 20% (in particular 10%, 5%, 2% or 1%) of the corresponding extent of the luminophore body. A planar extent can be understood to mean for example a diameter (e.g. in the case of a total luminous spot having a round basic shape), an edge length or a diagonal (e.g. in the case of a total luminous spot having a rectangular or hexagonal basic shape).

The extent and/or the shape of the total luminous spot may be given in particular by the extent and/or the shape of an enveloping contour of the total luminous spot. The enveloping contour may be in particular the imaginary line of minimal length that surrounds all individual luminous spots of a total luminous spot. It surrounds a closed area in which all the individual luminous spots lie. In the case of a rectangularly matrix-shaped arrangement of the individual luminous spots, the associated enveloping contour may have a rectangular basic shape, etc. The fact that the shape of the total luminous spot or the shape of its enveloping contour has a specific (e.g. rectangular, hexagonal, circular, oval, freeform-shaped, etc.) basic shape may include the fact that at least one part of the edges is embodied in a curved fashion, the basic shape having e.g. rounded edges.

In a configuration that is advantageous for avoiding light losses, at least one individual primary light beam is incident on the luminophore body at a Brewster angle, since a surface reflection is kept particularly low in this way.

Furthermore, in one development, the illumination device is coupled to at least one sensor (e.g. to a camera) and the individual primary light beams or the associated luminous spots are switchable on and off depending on a measurement value of the at least one sensor. As a result, in the case of a traveling vehicle, if a pedestrian or an animal was spotted by means of a front camera, those luminous spots which illuminate this object in the associated light emission pattern can be entirely switched off. This reduces dazzling of the object. Such an adaptation of the light emission pattern can also be referred to as “dynamic” or “active” adaptation. A further possibility for dynamic adaptation consists in switching on or off individual primary light beams or associated luminous spots depending on a value of an external light sensor. Furthermore, there is the possibility of the switching on and off being adjustable or variable via an interface interacting with the vehicle, for example a software application (“app”) or a position signal (GPS, etc.). In this regard, for example, users of a vehicle can perform an adaptation of the light emission pattern that is permissible within the scope of legal standards, depending on the weather situation (fog, rain, snow, etc.) or depending on age, state of the eyes and other preferences.

In addition, in another configuration, the illumination device is a projection device. The latter is understood to mean in particular a device provided for illuminating a region at a distance from the projection device, in particular a far field. The far field can denote e.g. a spatial region in front of the illumination device starting from a distance of approximately one meter, in particular starting from a distance of approximately five meters.

Moreover, in another configuration, the illumination device is a vehicle headlight or an effect illumination device (e.g. a stage or disco illumination). However, the illumination device can also be an image projector.

For the case of a vehicle headlight, the associated vehicle can be a motor vehicle such as an automobile, a truck, a bus, a motorcycle, etc., an aircraft such as an airplane or a helicopter, or a watercraft. The illumination device can in principle also be some other illumination device of a vehicle, for example a rear light.

The illumination device can have a safety function which achieves the effect that, in the event of damage to the illumination device, light (in particular primary light) emerging from the latter cannot have a harmful effect. In particular, the radiation emitted by the illumination device is kept within a photobiologically harmless amount, e.g. by means of a design configuration and/or by means of switching off the semiconductor primary light sources (“automatic switching-off mechanism”). The automatic switching-off mechanism can trigger e.g. in a sensor-controlled manner, for example on the basis of measurement values of a distance sensor, a camera, an airbag sensor, etc. The damage may include damage or removal of the luminophore body. The damage can be caused by an accident.

### BRIEF DESCRIPTION OF THE DRAWINGS

The above-described properties, features and advantages of this present disclosure and the way in which they are achieved will become clearer and more clearly understood in association with the following schematic description of embodiments which are explained in greater detail in association with the drawings. In this case, identical or identically acting elements may be provided with identical reference signs for the sake of clarity.

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows an illumination device in accordance with a first embodiment as a sectional illustration in a cross-sectional view;

FIG. 2 shows a total luminous spot on a luminophore body of the illumination device;

FIG. 3 shows a plot of a spatial luminance distribution from FIG. 2;

FIG. 4 shows a further plot of a spatial luminance distribution;

FIG. 5 shows yet another possible plot of a spatial luminance distribution;

FIG. 6 shows in a frontal view a luminophore body with a possible track of the total luminous spot;

FIG. 7 shows in a frontal view a luminophore body with an illustration of temporally successive total luminous spots and the temporal integration thereof;

FIG. 8 shows an illumination device in accordance with a second embodiment as a sectional illustration in a cross-sectional view; and

FIG. 9 shows an illumination device in accordance with a third embodiment as a sectional illustration in a cross-sectional view.

### DETAILED DESCRIPTION

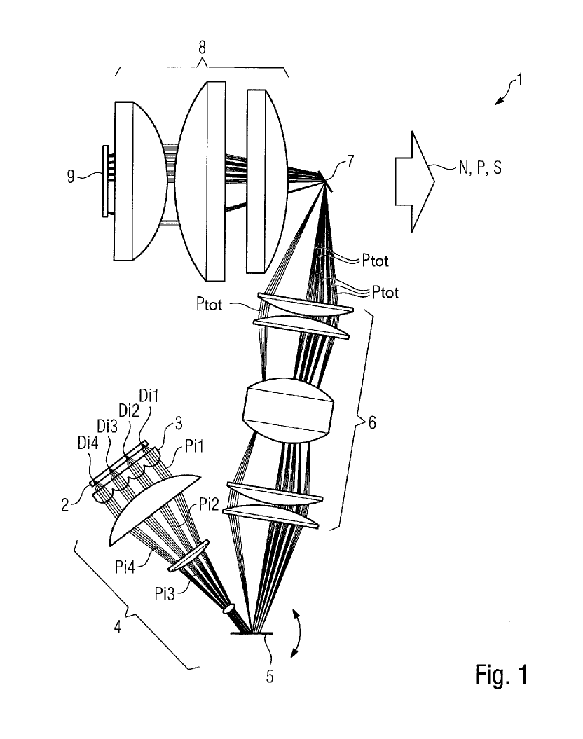

FIG. 1 shows an illumination device 1 in accordance with a first embodiment as a sectional illustration in a cross-sectional view.

The illumination device 1 includes a multi-die package 2, on which twenty (20) semiconductor primary light sources in the form of laser chips Dij where for example i=1, . . . , m and j=1, . . . , n are arranged in a matrix-shaped (m×n) pattern where m=5, n=4. The laser chips, of which here only the laser chips Di1 to Di4 of a column i are shown, emit associated individual primary light beams Pij in the form of laser beams, of which here also only the associated four primary light beams Pi1 to Pi4 are shown. All the primary light beams Pij here consist for example of blue light and are also identical with regard to their radiation profile. The primary light beams Pij are emitted parallel to one another.

The individual primary light beams Pij pass through a first optical unit 3, which allows individual beam shaping of the individual primary light beams Pij, e.g. beam collimation, for example for individual “parallel alignment” of all the individual primary light beams Pij. The first optical unit 3 can also be referred to as “primary optical unit”.

A second optical unit 4 common to all the primary light beams Pij is disposed downstream of the first optical unit 3 and brings the primary light beams Pij spatially closer together and, if appropriate, also reduces their cross-sectional area and directs them onto a first mirror in the form of a micromirror 5. The second optical unit 4 may also be referred to as a “telescope optical unit”. The primary light beams Pij can impinge on the micromirror 5 in a parallel fashion or in a manner angled with respect to one another.

The micromirror 5 can be rotated for example in a continuously variable or stepwise manner about two rotation axes, which here could lie e.g. perpendicular to the plane of the drawing and in the plane of the drawing parallel to a mirror surface of the micromirror 5. The latter can assume a plurality of different angular positions in relation to each of the two rotation axes. The deflection angle of the micromirror can be up to +/−12° e.g. in both rotation directions.

The micromirror 5 deflects the primary light beams Pij, which are now close together in a total light beam Ptot, through a third optical unit 6 onto a rigid deflection mirror 7. FIG. 1 depicts total light beams Ptot which are associated with different angular positions of the micromirror 5 and are picked out by way of example for this purpose, which total light beams can be generated temporally successively during operation of the illumination device 1.

The deflection mirror 7 directs the individual primary light beams Pij or the total light beam Ptot composed thereof through a fourth optical unit 8 onto a luminophore body 9. A diameter of the fourth optical unit 8 is advantageously 70 mm or less for automotive applications.

The luminophore body 9 is embodied here as a planar ceramic lamina, which can bear on a reflective support (not illustrated), for example, at its side facing away from the incident primary light beams Pij. The support can also act as a heat sink.

The luminophore body 9 can thus be simultaneously illuminatable maximally by all the primary light beams Pij in an angular position of the micromirror 5. However—in particular also depending on the angular position—one or more primary light beams Pij can be switched off or not be emitted.

The blue primary light beams Pij can be at least partly wavelength-converted, specifically into secondary light of at least one other wavelength, e.g. of a yellow color, by the luminophore situated in the luminophore body 9 (e.g. a luminophore including cerium-doped yttrium aluminum garnet (YAG), which converts blue primary light at least partly into yellow secondary light). The luminophore body 9 here emits the useful light N from the same side on which the primary light beams Pij also impinge, said useful light being composed of a mixture of a primary light portion P and a secondary light portion S (“reflective arrangement”). In this case, the fourth optical unit 8 also serves as a coupling-out optical unit or as a part of a coupling-out optical unit for the useful light N, in particular for projection into a far field. The useful light N can be e.g. a blue-yellow or white mixed light.

The deflection mirror 7 can belong to the third optical unit 6 and/or to the fourth optical unit 8, or else not constitute a component of said optical units 6, 8.

In an alternative development, both mirrors 5 and 7 can be rotatable mirrors having different rotation axes, in particular micromirrors. In this regard, the mirror 5 may then be rotatable only about a first rotation axis D1 and the mirror 7 may be rotatable only about a second rotation axis D2.

In another alternative development, the mirror 7 can be the micromirror, and the mirror 5 can be the rigid deflection mirror. This affords the advantage that the third optical unit 6 can also be omitted.

As a result of the different angular positions of the micromirror 5 (or e.g. alternatively of the mirror(s) 5 and/or 7, etc.) all the primary light beams Pij incident on the micromirror 5 can be moved jointly, thus also resulting in a corresponding movement of the associated luminous spots Fij on the luminophore body 9. This corresponds to a changed deflection of a total light beam Ptot composed of the individual primary light beams Pij, or of the total luminous spot Ftot. As a result, a total luminous spot Ftot composed of the individual luminous spots Fij of the respective primary light beams Pij is spatially distinguishable on the at least one luminophore body 9 depending on the angular position of the micromirror 5. In other words, total luminous spots Ftot associated with different angular positions of the micromirror 5 differ spatially at the luminophore body 9 or are arranged disjointly with respect to one another at the luminophore body 9.

In addition, the primary light beams Pij can be switched on and off individually or in groups during operation of the illumination device 1.

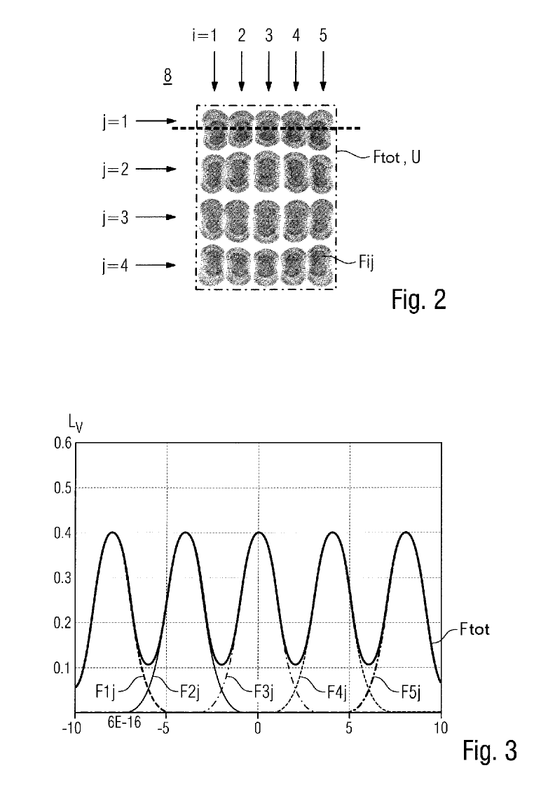

FIG. 2 shows in a frontal view the luminophore body 9 with all the simultaneously generatable individual luminous spots Fij. The individual luminous spots Fij form a total luminous spot Ftot on the luminophore body 9 of the illumination device 1. The luminous spots Fij are generated by a respective primary light beam Pij.

The luminous spots Fij are illustrated such that they are spatially distinguishable on the luminophore body 9 and e.g. practically do not overlap here. The luminous spots Fij—as also the primary light beams Pij directly before impinging on the luminophore body 9—form a matrix-like (m×n) pattern having m=5 columns and n=4 lines. The luminous spots Fij are practically uniform here.

The extent and/or the shape of the total luminous spot Ftot is determined by an enveloping contour U that surrounds all the individual luminous spots Fij with minimal length. It surrounds a closed area in which all the individual luminous spots Fij lie. In the case of the rectangularly matrix-shaped arrangement of the individual luminous spots Fij as shown here, the associated enveloping contour has a rectangular basic shape, which if appropriate can have rounded corners. If all the luminous spots Fij are switched on, the associated total luminous spot Ftot can also be referred to as “maximum” total luminous spot Ftot.

FIG. 3 shows a plot of a spatial luminance distribution of a line j of the luminous spots Fij with the columns i=1 to 5 from FIG. 2 and of the total luminous spot Ftot resulting therefrom by superimposition.

The luminous spots Fij are arranged disjointly since their luminance peaks and/or their geometric centers do not coincide.

The luminous spots Fij are furthermore spatially separated from one another since they overlap only in the case of a luminance Lᵥ that is less than e.g. 60% or than 1/e≈36.8% of the maximum value of the luminance Lᵥ of the respective luminous spots, namely here with ranges including less than 12.5% of the maximum luminance Lᵥ. As a result, the total luminous spot Ftot arising as a result of superimposition also exhibits local brightness peaks which are clearly separated from one another and which correspond to the peaks of the individual luminous spots Fij.

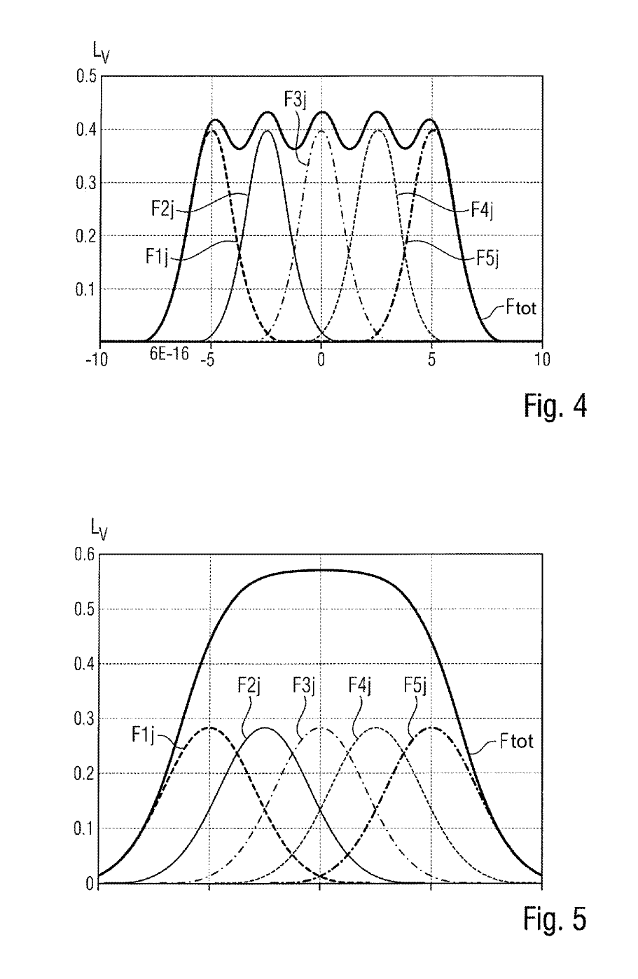

FIG. 4 shows a further plot of a further spatial luminance distribution of a line j of disjoint luminous spots Fij where i=1 to 5 and of the total luminous spot Ftot resulting therefrom by superimposition.

In contrast to FIG. 3, the individual luminous spots Fij here overlap partly if the criterion of 1/e of the maximum luminance Lᵥ as value of an edge of the luminous spots Fij is assumed. In comparison with FIG. 3, the luminous spots Fij, given the same luminance profile or given the same shape of the luminance distribution, are at a different lateral distance from one another. This analogously applies to the individual primary light beams Pij at the location of the luminophore body 9. As a result, although the total luminous spot Ftot arising as a result of superimposition still exhibits local brightness peaks which are clearly separated from one another and which correspond to the peaks of the individual luminous spots Fij, the brightness peaks of the total luminous spot Ftot are not as pronounced as in FIG. 3.

FIG. 5 shows yet another plot of a further possible spatial luminance distribution of a line j of disjoint luminous spots Fij where i=1 to 5 and of the total luminous spot Ftot resulting therefrom by superimposition.

The luminous spots Fij here overlap to an even greater extent than in FIG. 4 (but not entirely), such that the total luminous spot Ftot no longer exhibits pronounced local luminance maxima. To that end, the luminous spots Fij have a wider luminance profile in comparison with FIG. 4, with the same distance between one another. FIG. 5 thus differs from FIG. 3 both in the distance between the luminous spots Fij and in the luminance profile thereof.

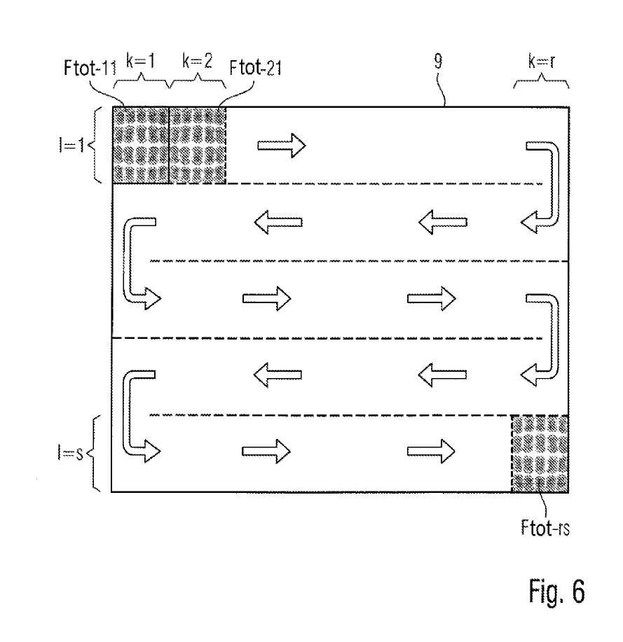

FIG. 6 shows in a frontal view a luminophore body 9 with a possible, purely exemplary track of the total luminous spot Ftot. The total luminous spot Ftot is moved over the luminophore body 9 by pivoting or rotation of the micromirror 5 successively such that the luminophore body 9 is illuminatable by the total luminous spot Ftot in a line-wise manner. This can also be referred to as a line scan. In this case, a plurality of lines l=1, . . . , s are illuminated or “scanned” one below another, and k=1, . . . , r total luminous spots Ftot are generated alongside one another in each of the 1 lines. Overall this results in a (r×s) matrix pattern of total luminous spots Ftot. To that end, the micromirror 5 (or alternatively movable mirrors 5 and/or 7) has at least (r×s) possible angular positions. In this case, the micromirror 5 can be adjustable in a continuously variable or practically continuously variable manner such that in principle any other angular positions desired can also be assumed.

The total luminous spots Ftot at the positions k, 1 (which hereinafter may also be designated as Ftot-kl) advantageously directly adjoin one another, but do not overlap, but rather are spatially separated from one another. The time duration required to scan the total luminous spot Ftot over all positions 1, . . . , r and 1, . . . , s is also referred to as “image set-up time”, and the associated frequency as “image set-up frequency”. The image set-up frequency for sufficiently high temporal resolution of a light emission pattern even in a far field is advantageously at least 50 Hz, particularly advantageously at least 75 Hz, particularly advantageously at least 100 Hz, especially advantageously at least 200 Hz.

The individual luminous spots Fij form a ([i·k]×[j·l]) matrix pattern on the luminophore body 9. Since the individual luminous spots Fij are individually switchable on and off, this affords the possibility of providing a high resolution matrix array of individual luminous spots Fij and thus also a corresponding light emission pattern from the luminophore body 9. This is particularly advantageous for use with an adaptive or active headlight.

The illumination device 1 can for example include a memory (not illustrated) or be coupled to a memory in which is stored a look-up table that links each angular position of the micromirror 5 with at least one on or off state of the individual luminous spots Fij or of the total luminous spot Ftot. Consequently, an on or off state can be allocated to each individual luminous spot Fij individually or in groups. The links between the angular positions and the respective on or off states can be different for different applications. In this regard, the illumination device 1 can serve as a vehicle headlight, wherein for example different links for a low beam for driving on the right, for a low beam for driving on the left, for a low beam according to US provisions, for a low beam according to ECE standards, for a fog light, for a high beam, etc. can be stored in the look-up table.

It is also possible for the illumination device 1 to be coupled to at least one sensor (e.g. a camera) and for the individual luminous spots Fij and/or the total luminous spot Ftot (or the corresponding primary light beams Pij and/or Ptot) to be switchable on and off depending on a measurement value of the at least one sensor. In this regard, in the case of a traveling vehicle, if a pedestrian or an animal was spotted by means of a front camera, those luminous spots Fij which illuminate said object in the associated light emission pattern can be switched off. This reduces dazzling of the object. A situation-dependent adaptation of the on or off state of at least one primary light beam Pij is generally possible. A further possibility for a situation-dependent adaptation may consist in a variation of the switch-on pattern of the individual luminous spots Fij depending on a value of an external light sensor.

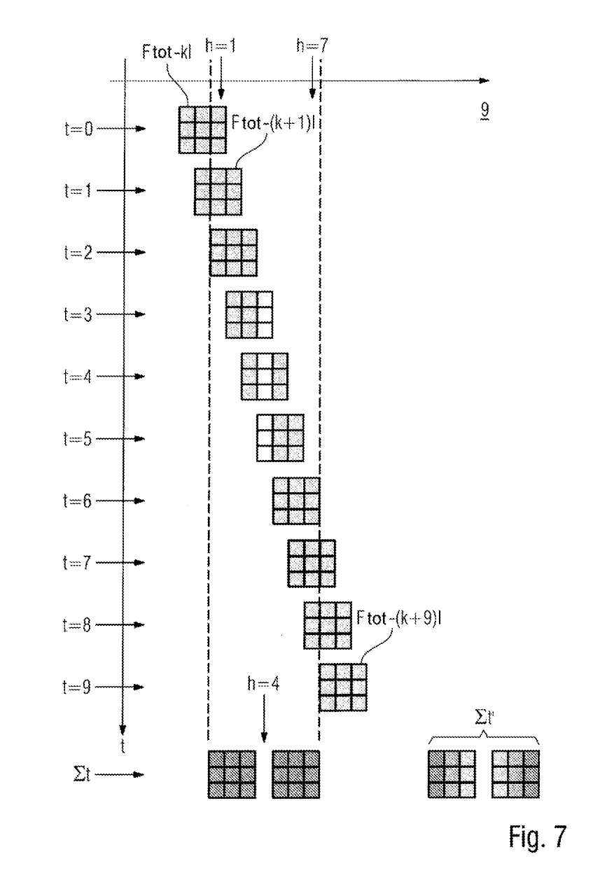

FIG. 7 shows in a frontal view a luminophore body 9 with an illustration of positions of temporally successive total luminous spots Ftot−(k+t)l (where t=0, . . . , 9) and the temporal integration “Σ t” thereof. In this case, the total luminous spots Ftot-(k+t)l are established purely by way of example as a 3×3 matrix of individual luminous spots Fij. A temporal sequence is indicated by the vertical axis t for ten time segments t=0, . . . , 9, which correspond to correspondingly successive angular positions of the micromirror 4 and thus also to the temporally successive positions of the total luminous spots Ftot-kl.

As indicated by the horizontal axis, which specifies a position of the total luminous spots Ftot−(k+t)l in an arbitrary, but then fixedly chosen line 1 on the luminophore body 9, temporally successive total luminous spots Ftot−(k+t)l can overlap at least in a column-wise manner, that is to say in particular that a total luminous spot Ftot−(k+t)l and an adjacent total luminous spot Ftot−(k+t+1)l are offset with respect to one another by an (individual) column h of individual luminous spots Fij where i=const. The associated overlap region thus has a width of two columns of individual luminous spots Fij. Each of the individual luminous spots Fij of a total luminous spot Ftot−(k+t)l has an arbitrary, but then fixedly chosen luminance Lν=Lc.

In addition, for a region—selected by way of example—of the line 1 of the luminophore body 9 which lies between the dashed lines, a temporal integration or summation “Σt” of the luminance Lν of the individual luminous spots Fij is recorded, e.g. in accordance with ∫ₜ₌₀^{t=9}Lν(t)dt or in accordance with Σₜ₌₀^{t=9}Lν(t) where Lν=Lc or 0. The selected region has a width of seven (individual) columns h of individual luminous spots Fij, specifically corresponding to the (individual) columns h=1 to h=7, as will be explained in greater detail below.

With respect to the first time segment shown around a point in time t=0, all the individual luminous spots Fij of a total luminous spot Ftot−kl are switched on. As a result, the associated three individual luminous spots F3j where j=1, . . . , 3 are generated at the individual column h=1 of the selected region. Each of the individual luminous spots Fij has a luminance Lν=Lc. Consequently, a quantity of light Q=Qc is emitted by each of the individual luminous spots Fij during the first time segment. No luminous spots Fij are generated at the other columns h=2, . . . , 7 of the selected region since the total luminous spot Ftot−kl does not project as far into the selected region.

With respect to a second time segment where t=1, the micromirror 4 has been rotated further by an angular position, such that a subsequent total luminous spot Ftot−(k+1)l is now generated. The total luminous spot Ftot−(k+1)l, too, is generated by virtue of all of the possible nine individual luminous spots Fij are switched on. Within the selected region, luminous spots Fij are thus generated at the individual columns h=1 and h=2. No luminous spots Fij are generated at the other columns h=3, . . . , 7 of the selected region.

With respect to a third time segment where t=2, the micromirror 4 has been rotated further by another angular position, such that a total luminous spot Ftot-(k+2)l lying entirely within the selected region is now generated. The total luminous spot Ftot−(k+2)l, too, is generated by virtue of all the possible nine individual luminous spots Fij being switched on. Within the selected region, consequently, luminous spots Fij are generated at the individual columns h=1 to h=3.

With respect to a fourth time segment t=3, the micromirror 4 has been rotated further by another angular position, such that a total luminous spot Ftot-(k+3)l also lying entirely within the selected region is now generated. The total luminous spot Ftot−(k+3)l is generated by virtue of only the left and middle columns of the individual luminous spots Fij being switched on, but not the right column. Consequently, only the individual luminous spots Fij where i=1 and are generated. Correspondingly, in the selected region, luminous spots Fij are generated only at the individual columns h=2 and h=3 (where Lν=Lc thus holds true), but not at the column h=4 (where Lν=0 thus holds true).

With respect to a fifth time segment where t=4, the micromirror 4 has been rotated further by another angular position, such that a total luminous spot Ftot-(k+4)l also lying entirely within the selected region is now generated. The total luminous spot Ftot−(k+4)l is generated by virtue of only the left and right columns of the individual luminous spots Fij being switched on, but not the right column. In other words, only the individual luminous spots Fij where i=1 and are generated. Correspondingly in the selected region, luminous spots Fij are generated only at the individual columns h=3 and h=5, but not in the column h=4.

With respect to a sixth time segment where t=5, the micromirror 4 has been rotated further by another angular position, such that a total luminous spot Ftot-(k+5)l also lying entirely within the selected region is now generated. The total luminous spot Ftot−(k+5)l is generated by virtue of only the middle and right columns of the individual luminous spots Fij being switched on, but not the right column. In other words, only the individual luminous spots Fij where i=2 and are generated. Correspondingly, in the selected region, luminous spots Fij are generated only at the individual columns h=5 and h=6, but not at the column h=4.

With respect to seventh to tenth time segments where t=6 to t=9, the micromirror 4 has analogously been rotated further by another angular position in each case, wherein the total luminous spot Ftot−(k+t)l is generated in each case by all the possible nine individual luminous spots Fij being switched on.

Upon temporally integral consideration of the columns h=1 to h=7 of the selected region, a luminous pattern designated by “Σ t” results. If an individual luminous spot Fij for one of the time segments t=0, . . . , 7 has a specific luminance Lν=Lc or emits a quantity of light Q=Qc, a region which is stationary in relation to the luminophore body 9 and at which individual luminous spots Fij are generated emits a quantity of light which results from an integration or summation of the quantity of light Q generated there in the time segments t=0 to 7 or the luminance Lν of the luminous spots Fij that is present there. Since each of the columns h=1 to 3 and 5 to 7 is illuminated at three successive time segments t, a stationary region present there emits the quantity of light 3·Qc (and a column h thus emits overall the quantity of light 9·Qc). By contrast, no light is emitted by the column h=4. Consequently, the overlapping sequence of total luminous spots Ftot−kl as shown in FIG. 7 can achieve a particularly sharp resolution in conjunction with a high quantity of light Q, namely here regions having a high quantity of light 3·Qc (corresponding to an integrated luminance Lν=3·Lc) which are separated from one another by a narrow, dark gap where Q=0 or Lν=0 (corresponding to the narrow gap h=4). Besides being made possible by the column-wise overlap, this is made possible by the capability of selectively switching the individual luminous spots Fij on and off.

If the capability for column-wise overlap were provided, but not the capability for selective switching on and off, and if the total luminous spots Ftot−kl could thus only be switched on and off completely, in order to generate a dark gap where Q=0 the luminous spots Ftot−kl would have to be switched off entirely at the time segments t=3 to t=5, which would generate the luminous pattern “Σt′” in the selected region. However, adjoining the gap h=4 corresponding to the dark gap (i.e. at the columns h=3 and h=5) the luminous pattern “Σt′” does not have the quantity of light 3·Q per stationary region, but rather only Q. Even further out (i.e. at the columns h=2 and h=6) a quantity of light 2·Q is emitted per stationary region. It is only at the columns h=1 and h=7 that a quantity of light 3·Q is emitted per stationary region. In other words, in this case a distance between columns having the highest quantity of light 3·Q per stationary region is five gaps or gap widths, while a distance of only one gap or only one gap width and thus a considerably higher resolution are achievable in the case of the illumination device according to the present disclosure.

In principle, the total luminous spots Ftot−kl can also each be composed individually of individual luminous spots Fij and thus generate an intensity-step-like luminance pattern given column-wise overlapping, even though the individual luminous spots Fij are just simply switchable on and off or activatable and deactivatable. In principle, the total luminous spots Ftot−kl can be generated on the luminophore body 9 in any desired order at any desired positions with any desired scan directions, if appropriate also repeatedly at the same position within an image set-up time.

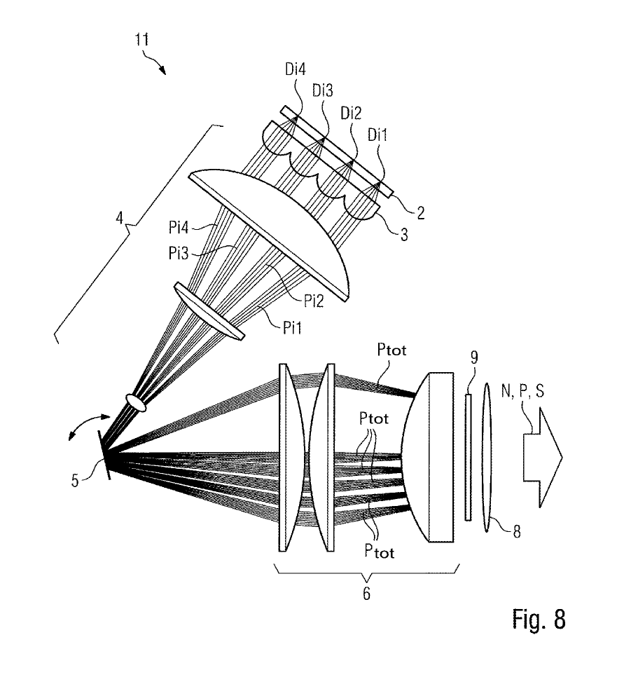

FIG. 8 shows an illumination device 11 in accordance with a second embodiment as a sectional illustration in a cross-sectional view.

The illumination device 11 differs from the illumination device 1 in particular in that the for example white or whitish useful light N, which corresponds to the mixture of converted secondary light S and unconverted primary light P, is emitted at that side of the luminophore body 9 which faces away from the incident primary light beams Pij. In the case of this “transmitting” or “transmissive” arrangement, the fourth optical unit 8 (indicated here by a lens) is also situated on that side of the luminophore body 9 which emits the useful light N. Moreover, the deflection mirror 7 is dispensed with here, which however is also possible, in principle, in the case of the illumination device 1.

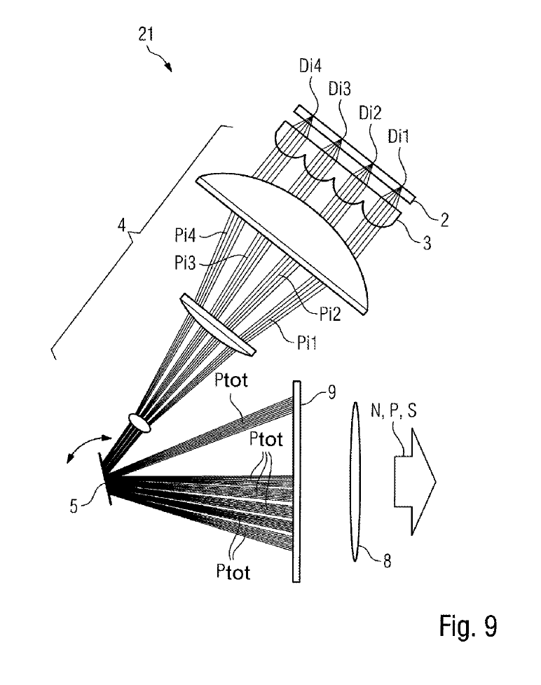

FIG. 9 shows an illumination device 21 in accordance with a third embodiment as a sectional illustration in cross-sectional view.

The illumination device 21 differs from the illumination device 11 in that the third optical unit 6 is dispensed with. While a focusing of the primary light beams Pij impinging on the luminophore body 9 is effected, inter alia, by the third optical unit 6 in the case of the illumination devices 1 and 11, this is performed by the second optical unit 4 in the illumination device 21. Therefore, said second optical unit now need no longer be embodied in a “telescope-like” fashion.

The six different total primary beams Ptot shown in FIG. 1, FIG. 8 and FIG. 9 can generate respective different total luminous spots Ftot−kl and can therefore also be referred to as total primary beams Ptot−kl.

Although the present disclosure has been more specifically illustrated and described in detail by means of the embodiments shown, the present disclosure is not restricted thereto and other variations can be derived therefrom by the person skilled in the art, without departing from the scope of protection of the present disclosure.

In this regard, the primary light beams Pij can also all impinge on the luminophore body obliquely. Said luminophore body can be inclined such that the primary light beams Pij impinge on it at least approximately at a Brewster angle.

Moreover, a luminophore body can generally be illuminatable by a plurality of sets of in each case a plurality of semiconductor primary light sources and at least one movable mirror as described above. The illuminatable areas of the luminophore body which are associated with different sets can be spatially disjoint, in particular. Alternatively, a common area of the luminophore body may be illuminated in a temporally and/or spatially offset manner by the sets. In the case of spatially offset illumination, a luminophore body can be illuminated by different sets in particular on different tracks or on the same track (e.g. in opposite directions). In the case of only temporally offset illumination, a luminophore body can be illuminated by different sets in particular on the same track in the same direction.

In addition, a column-like scanning or an arbitrary scanning can be used analogously to a line-like scanning or illumination sequence.

Generally, “a(n)”, “one”, etc. can be understood to mean a singular or a plural, in particular in the sense of “at least one” or “one or a plurality”, etc., as long as this is not explicitly excluded, e.g. by the expression “exactly one”, etc.

Moreover, a numerical indication can encompass exactly the indicated number and also a customary tolerance range, as long as this is not explicitly excluded.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

### REFERENCE SIGNS

1 Illumination device
2 Multi-die package
3 First optical unit
4 Second optical unit
5 Micromirror
6 Third optical unit
7 Deflection mirror
8 Fourth optical unit
9 Luminophore body
11 Illumination device
21 Illumination device
Dij Laser chip
Ftot Total luminous spot
Ftot−kl Total luminous spot at position (k,l)
Fij Individual luminous spot
N Useful light
P Primary light portion
Ptot Total light beam
Pij Primary light beam
S Secondary light portion
Σt Luminous pattern
Σt′ Luminous pattern
U Enveloping contour

1. An illumination device, comprising
a plurality of semiconductor primary light sources for emitting respective primary light beams, a beam deflection unit, which is illuminatable by the primary light beams and which can assume at least two beam deflection positions, and
a luminophore body, which is illuminatable by primary light beams deflected by the beam deflection unit, and
wherein
luminous spots of the individual primary light beams are spatially distinguishable on the at least one luminophore body,
a total luminous spot composed of the luminous spots of the individual primary light beams is spatially distinguishable on the at least one luminophore body depending on the beam deflection position of the beam deflection unit, and
at least one primary light beam incident on the at least one luminophore body is selectively switchable on and off during operation of the illumination device.

2. The illumination device as claimed in claim 1, wherein the beam deflection unit comprises at least one movable mirror, which is illuminatable by the primary light beams and which can assume at least two angular positions as beam deflection positions.

3. The illumination device as claimed in claim 2, wherein the at least one movable mirror comprises at least one micromirror.

4. The illumination device as claimed in claim 1, wherein total luminous spots associated with different beam deflection positions at least partly overlap.

5. The illumination device as claimed in claim 4, wherein at least two luminous spots of individual primary light beams which belong to different total luminous spots can be superimposed.

6. The illumination device as claimed in claim 5, wherein at least two series of luminous spots of individual primary light beams which belong to different total luminous spots can be superimposed.

7. The illumination device as claimed in claim 1, wherein total luminous spots associated with different beam deflection positions are spatially separated from one another.

8. The illumination device as claimed in claim 1, wherein a switch-on pattern of the generatable luminous spots is dependent on the beam deflection position of the beam deflection unit.

9. The illumination device as claimed in claim 1, wherein the primary light beams are laser beams.

10. The illumination device as claimed in claim 1, wherein the at least one luminophore body is illuminatable in a track-like manner with a total light beam constituted by the individual primary light beams.

11. The illumination device as claimed in claim 1, wherein the total luminous spot has a planar extent which does not exceed 20% of a corresponding extent of the luminophore body, in particular does not exceed 10%, in particular 5%, in particular 2%, in particular 1%.

12. The illumination device as claimed in claim 1, wherein the illumination device is a projection device.

13. The illumination device as claimed in claim 12, wherein the illumination device is a vehicle headlight or an effect illumination device.
